(19) United States
(12) Patent Application Publication
(10) Pub. No.: US 2007/0262933 A1
(43) Pub. Date: Nov. 15, 2007

(54) System and method for mounting LED's on a display surface

(75) Inventor: Paul Streitz, Sauk Centre, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Advanced Lighting Systems, Inc. a Minnesota corporation

(21) Appl. No.: 11/432,672

(22) Filed: May 11, 2006

(51) Int. Cl. G09G 3/32

(52) U.S. Cl. 345/82

(57) ABSTRACT

A display system is provided, including a rigid or non-rigid display surface having a display side and a non-display side, with one or more holes being formed through the surface. In one embodiment the display surface is a non-rigid curtain. Multiple fasteners define central openings in and are arranged on the display side of the display surface, such that the central opening of each fastener is aligned with the holes. The system also includes light strings containing one or more light nodes. The light nodes include a light source, such as an LED or other suitable light source. The light strings and light nodes are arranged so that each light source protrudes from the non-display side of the display surface, through a corresponding hole to the display side of the display surface, and through the central opening of a corresponding fastener. The fastener is fixedly secured to the light node by compressing the fastener against the display side of the display surface and compressing the light node against the non-display side of the display surface.

### BACKGROUND OF THE INVENTION

A variety of lighting systems and other image display systems are increasingly employed for a variety purposes. Use of such systems in arenas, theatres and other public gathering areas or venues has become increasingly popular. Lighting systems of this nature may display or communicate stationary or animated images, patterns, and text on a large scale that is visible to sizeable audiences or from a distance. The effect of the large scale lighted display may enhance the entertainment or marketing value of the display.

One approach to achieving a large scale lighted display is bonding the tips of fiber optic strands to the back surface of a curtain. The other ends of the fiber optic strands may be attached to a programmable light source, which may be activated to illuminate visible pinpoints of light on the surface of the curtain. The pinpoints may display a variety of colors and intensities corresponding to the light source. This approach, however, imposes limitations on the types of usable light sources, as well as the shape and nature of the lights on the curtain surface.

Other systems provide for controlling light-emitting LEDs with a processor to affect the brightness and color of the generated light by using pulse-width modulated signals. The illumination may be driven by a computer program to provide a desired pattern of light. However, these systems do not affix the LED nodes at predetermined positions on a curtain surface to create an LED curtain display system.

Yet other systems provide for LED arrangements on display panels having a web structure. The LED's are mounted at predetermined points to form a matrix for projecting multi-color images. These types of displays, however, typically require an integrated support structure, such as visible towers and beams, and cannot be retracted or extended during operation.

Other systems attach LED display modules to a flexible net having a mesh portion. These systems make precise positioning of the individual LED modules difficult or impossible, resulting in unfocused images, and the connecting wires and LED mounting hardware remain visible to the audience or other viewers when the system is not activated, which results in an unattractive display.

### BRIEF SUMMARY OF THE INVENTION

A display system is provided, including a rigid or non-rigid display surface having a display side and a non-display side, with one or more holes being formed through the surface. In one embodiment the display surface comprises a panel, which may include such surfaces as a non-rigid curtain. Multiple fasteners define central openings in and are arranged on the display side of the panel, such that the central opening of each fastener is aligned with the holes. The system also includes light strings containing one or more light nodes. The light nodes include a light source, such as an LED or other suitable light source. The light strings and light nodes are arranged so that each light source protrudes from the non-display side of the panel, through a corresponding hole to the display side of the panel, and through the central opening of a corresponding fastener. The fastener is fixedly secured to the light node by compressing the fastener against the display side of the panel and compressing the light node against the non-display side of the panel.

### BRIEF DESCRIPTION OF THE DRAWINGS

FIG. 1A is a schematic view of the non-display side of a display system comprising LED light nodes connected to a computer in accordance with the present invention.

FIG. 1B is a schematic view of the display side of a display system comprising LED light nodes connected to a computer in accordance with the present invention.

FIG. 1C is a schematic view of the non-display side of a display system comprising LED light nodes connected to a computer and fiber optics connected to a fiber illuminator in accordance with the present invention.

FIG. 1D is a schematic view of the display side of a display system comprising LED light nodes connected to a computer and fiber optics connected to a fiber illuminator in accordance with the present invention.

FIG. 2 is a perspective view of a pre-assembled LED light node with fastening assembly and a display surface in accordance with the present invention.

FIG. 3 is a perspective view of a pre-assembled LED light node with fastening assembly and a display surface in accordance with the present invention.

FIG. 4 is a perspective view of a pre-assembled LED light node with fastening assembly and a display surface in accordance with the present invention.

FIG. 5 is an exploded view of a LED light node with fastening assembly and a display surface in accordance with the present invention.

FIG. 6 is a perspective view of an LED light node protruding through a display surface in accordance with the present invention.

FIG. 7 is a perspective view of an assembled LED light node with fastening assembly and a display surface in accordance with the present invention.

FIG. 8 is another perspective view of the assembled LED light node with fastening assembly and a display surface in accordance with the present invention seen in FIG. 7.

FIG. 9 is an exploded view of an LED light node with fastening assembly and a display surface in accordance with the present invention.

FIG. 10 is a perspective view of an assembled LED light node with fastening assembly and a display surface in accordance with the present invention.

FIG. 11 includes perspective views of the light node housing with a node head and a threaded shaft.

FIG. 12 includes perspective views of a round deep nut with internal threads.

### DETAILED DESCRIPTION OF THE INVENTION

The present invention is directed towards a system and method for mounting LED's on a display surface. The system includes a rigid or non-rigid surface having a display side and a non-display side. A variety of materials are suitable for comprising the material of the display surface. Appropriate non-rigid materials include vinyl, flexible plastic, carpet, fabric and cloth, including cotton, velour, polyester, denim, or blends thereof, etc. Appropriate rigid materials include wood, rigid plastic, sheetrock, walls, cement, metal, etc. These materials are merely exemplary, and those skilled in the art will appreciate that numerous other materials may be implemented within the scope and meaning of the present invention.

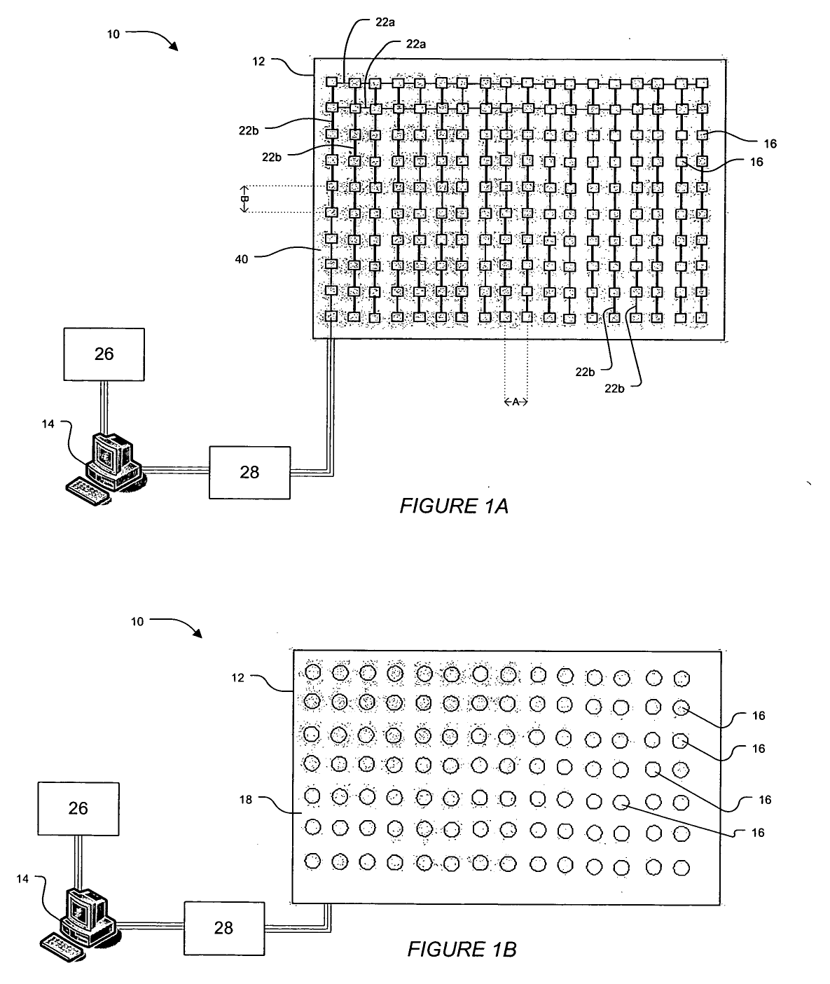

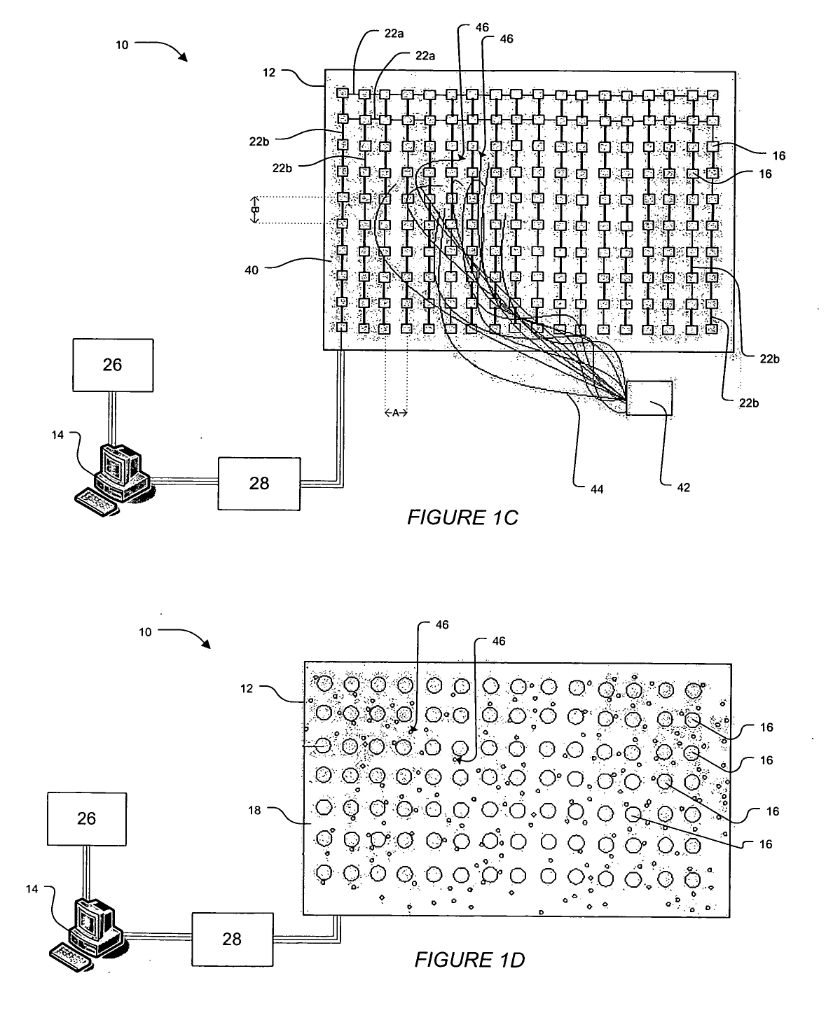

With reference to FIG. 1A, a schematic view of a non-display side 40 of a display surface in a display system 10 is shown in accordance with one embodiment of the present invention wherein the display surface is non-rigid. Although this embodiment described herein is directed towards a non-rigid display surface, which may include a curtain, the principles disclosed herein also apply to other non-rigid display surfaces and to rigid display surfaces. In this embodiment, the system 10 includes a display surface 12, which is in electrical connection with a video source 26, a related processor 14, and a power supply 28. In embodiments where display surface 12 is a curtain, it may be formed of a variety of suitable materials. For example, the surface may be made of a heat-retardant fabric or cloth that resists higher temperatures that may be introduced during operation of the display system. Additionally, the display surface is formed from a material sufficiently durable or thick to support a plurality of lights and attendant hardware, which are described in more detail below. For example, a surface thickness of 1.0 mm to 3.0 mm is suitable for many applications of the present invention. Further, the surface material is suitable to substantially obscure light from passing through the surface.

The display surface is assembled by forming a plurality of predetermined holes 20 in the surface at desired positions. The holes may be punched, cut, drilled, or formed with other suitable methods. A plurality of LED light nodes 16 containing preinstalled LED's are secured to display surface 12, such that the LED light nodes are visible on the display side 18, shown in FIG. 1B, of the display surface 12 through one of the holes 20. Each LED node includes at least three lights corresponding to the primary light colors: red, green, and blue. Other lighting means, including single-colored lights, are also suitable in accordance with the present invention. In one configuration, a string of LED light nodes is installed such that the string is mounted along the non-display side 40 of the display surface horizontally, vertically, diagonally, or in any desired configuration or design, with the light nodes protruding through corresponding holes 20 to the display side 18 of the surface. To create an enhanced lighting effect, multiple strings 22 of LED light nodes are installed on display surface 12.

The LED light string 22 may be formed from a three-wire 18 AWG cable 24, seen in FIGS. 6 and 8, and the LED light nodes 16 are spaced apart along the string at a uniform distance. The uniform distance may be any suitable length between LED light nodes for creating the desired lighting effect, such as 1″, 2″ 3″, 4″, 5″, 6″, 7″, 8″, or any other practical distance. Alternatively, random distances between LED light nodes may be used. For example, as seen in FIG. 1A, horizontally mounted strings 22a are positioned in equally spaced rows, and each string 22a provides a uniform spacing between LED light nodes indicated by distance A. Alternatively, as seen in FIG. 1A, strings 22b are mounted vertically in equally spaced columns, and each string 22b provides a uniform spacing between LED light nodes indicated by distance B. It will be appreciated that nonuniform and random distances between light nodes and a variety of practicable configurations or designs of light strings are possible and will yield distinct benefits.

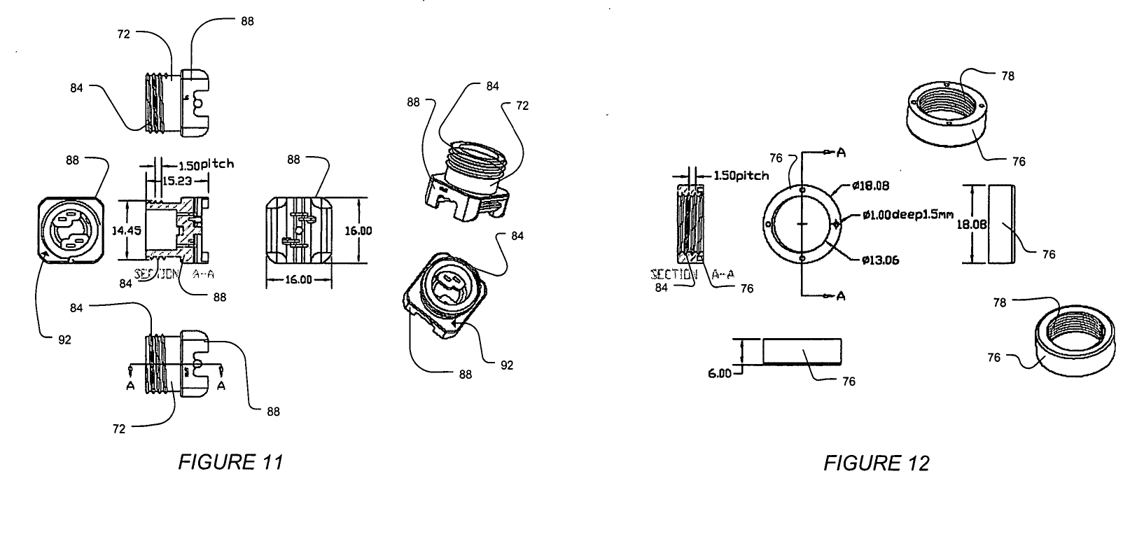

The light strings may be secured to the display surface through a number of means. In one embodiment, individual LED light nodes are coupled to the surface through one of the methods described below, and the wiring or cable 24 in the light strings is held in place relative to the surface by virtue of being attached to the LED light nodes. In alternative embodiments, the light strings are additionally secured to the display surface with an affixing material such as adhesive or a hook and loop fastener. For example, in one embodiment, an adhesive is applied on the non-display side 40 of the surface 12 surrounding the predetermined holes 20. When a light node is positioned through its corresponding hole, as described in more detail below, the light node's front surface 92, seen in FIG. 11, comes into contact with the adhesive and couples them together. In another embodiment, opposing materials of a hook and loop fastener are attached to the non-display side 40 of the surface 12 surrounding the predetermined holes and the light nodes' front surfaces 92 such that they are coupled together when they come into contact.

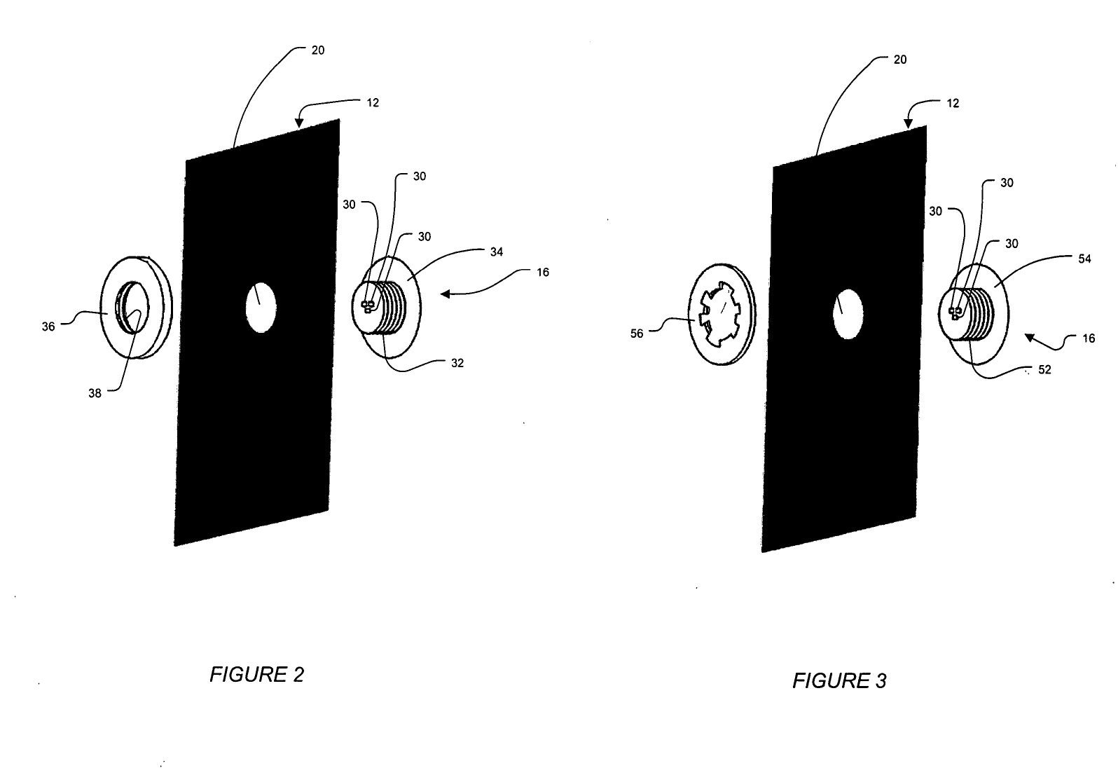

With reference to FIG. 2, each LED light node 16 includes one or more LED's 30 that are preinstalled within the node. A light node 16 further defines a node shaft 32 that is inserted through a predetermined hole 20 formed in the display surface 12. The node shaft 32 has a depth sufficient to extend through one of the predefined holes 20 from one side of the surface to the other and be received by an attachment means, such as nut 36. Each predetermined hole 20 is formed to substantially conform to the diameter of the node shaft 32 it is intended to receive. Accordingly, when a light node 16 is arranged in surface 12, the node shaft 32 will be comfortably received by its corresponding hole 12 until the node head 34 engages the surface. Node head 34 is an oversized flange having a diameter greater than the predetermined hole 20 in the display surface. The node shaft 32 is inserted from the non-display side 40 of the surface 12 and, after insertion into the surface, protrudes through to the display side 18 of the surface such that LED's 30 extend slightly beyond the display side 18 fabric and are visible from the display side 18. The node head 34 stops the node shaft 32 from protruding at the desired distance when the node head encounters the non-display side of the surface. Alternatively, the node head may be omitted from the light node.

A light node 16 node may be secured to surface 12 by a variety of configurations. In one embodiment, shown in FIG. 2, the node shaft 32 is threaded, and the node is coupled to the surface by a threaded nut 36 which defines internal threads 38. The threaded nut is effective for securing the light nodes to the display surface but are sufficiently subtle so it is not unduly noticeable or distracting to an audience or other viewer of the lighted display surface. During installation of the light node, the node shaft is received through the surface 12 by threaded nut 36, and the nut is turned which causes the internal threads 38 to grip the correspondingly sized threads on shaft 32. The nut may be pre-affixed to the display side 18 of the display surface prior to installation of the light node with glue or other suitable adhesive. The turning motion draws the node head 34 against the non-display side of the surface 12 and the threaded nut 36 against the display side 18 of the display surface until the node head is sufficiently compressed and secured against the surface. The nut 36 also may be glued to the light node 16, thereby securing the node to the surface. In either arrangement, the LED's 30 of the LED light node head 16 protrude through and are visible from the display side 18 of the display surface, and the securing nut 36 is also positioned on the display side 18 of the surface. Nut 36 functions both to affix the light node to the display surface in a desired location and to reinforce the hole 20, much like a grommet.

In an alternative embodiment, shown in FIG. 3, node shaft 52 is coupled to the display surface by an external grommet 56, which is appropriately sized to friction fit node shaft 52. During installation of the light node, the node shaft 52 is received through the surface 12. Grommet 56 is installed to friction fit around and to the portion of the node shaft that protrudes through the display side 18 of the surface such that node head 54 is sufficiently compressed and secured against the non-display side of the surface 12 and the grommet 56 is sufficiently compressed and secured against the display side 18 of the surface to fasten the light node to the display surface. In this arrangement, the LED's 30 of the LED light node 16 protrude through and are visible from the display side 18 of the surface, and grommet 56 is also positioned on the display side 18 of the surface. Grommet 56 also may be glued to the light node 16, thereby securing the node to the display surface, and node shaft 52 is optionally threaded to further couple the grommet to the node shaft.

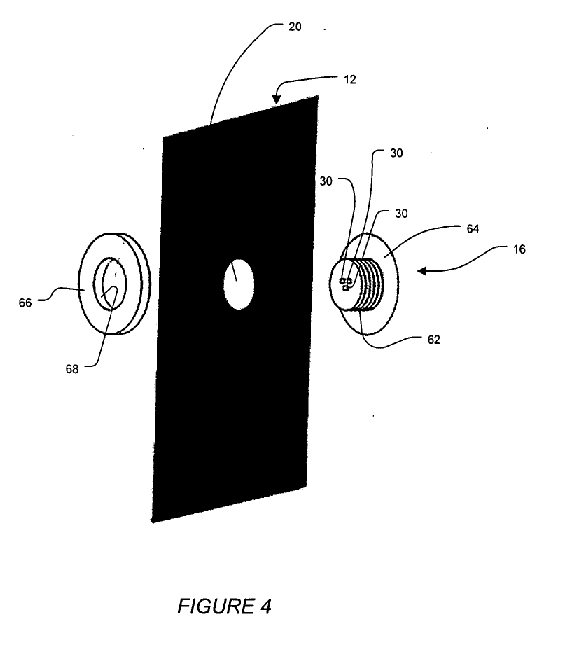

In another embodiment, shown in FIG. 4, node shaft 62 is coupled to the display surface by an external washer 66, which defines an opening 68 that is appropriately sized to receive node shaft 62. During installation of the light node, the node shaft 62 is received through the surface 12. External washer 66 is positioned around the portion of the node shaft that protrudes through the display side 18 of the surface. The external washer 66 is compressed against the display side 18 of the surface and node head 64 is compressed against the non-display side of the surface. The washer 66 is glued to the LED light node 16 such that they are sufficiently secured to each other to fasten the light node to the surface. In this arrangement, the LED's 30 of the LED light node head 16 protrude through and are visible from the display side 18 of the display surface, and external washer 66 is also positioned on the display side 18 of the surface. Node shaft 62 is optionally threaded as seen in FIG. 4.

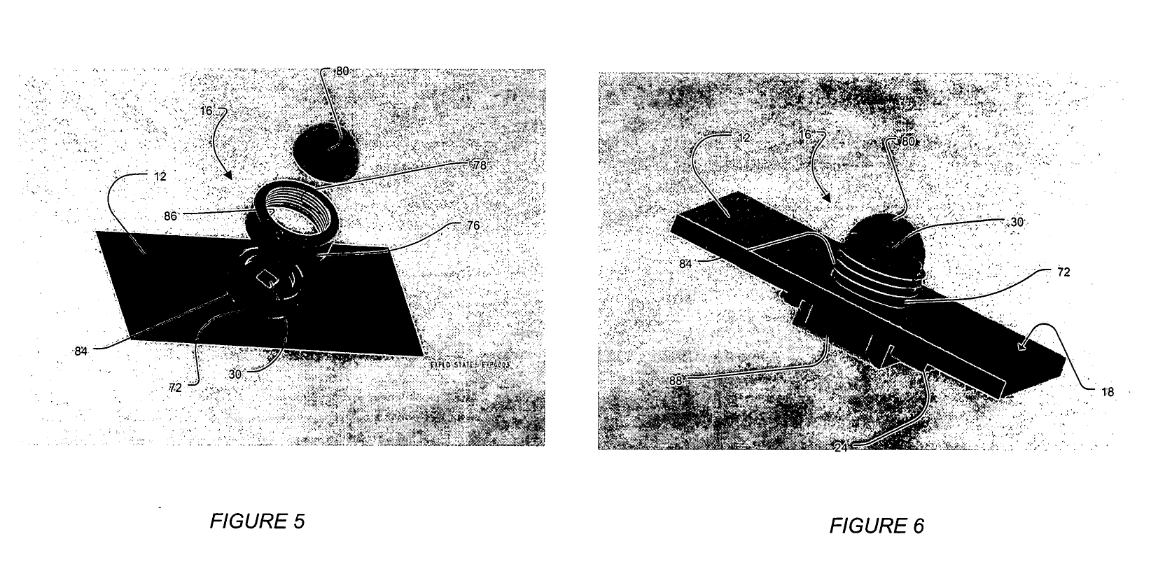

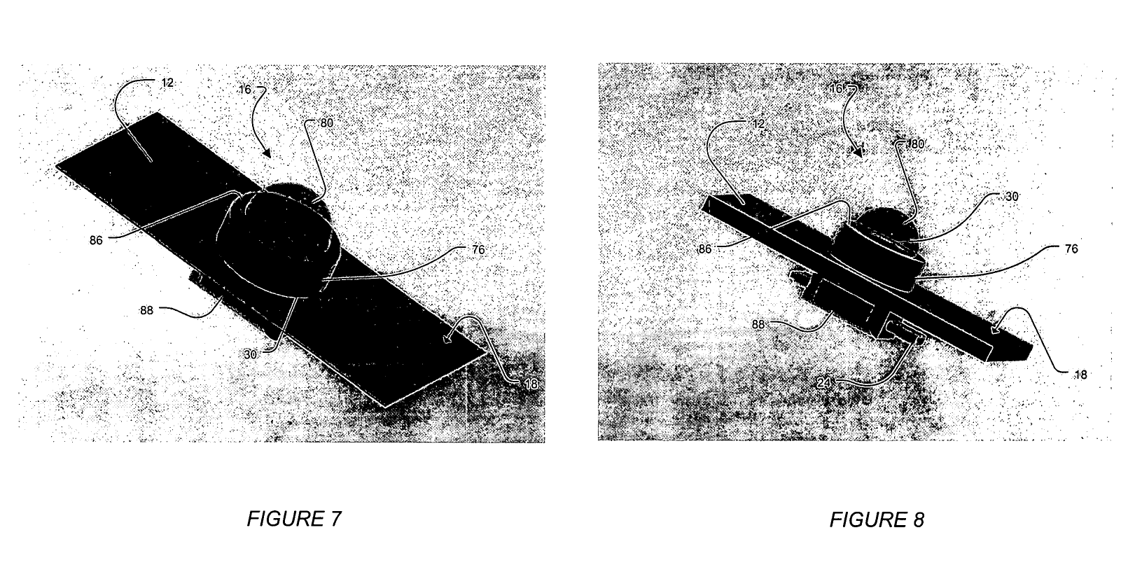

In yet another embodiment, shown in FIGS. 5-8, LED light node 16 is secured to a rigid or non-rigid display surface material 12 by a substantially round deep nut 76. The node shaft 72 forms threads 84, and the light node 16 is coupled to the display surface by nut 76 which defines internal threads 78. FIGS. 11 and 12 show a variety of perspective views of the light node housing and the nut 76 respectively. The light node 16 further includes a light dome 80 for protecting LED's 30. FIG. 5 is an exploded view of these components and illustrates their configuration as seen prior to installation. During installation of the light node, the node shaft 72 is received through the display surface 12 to its display side 18 and the light dome 80 is fitted over the LED's 30, as seen in FIG. 6. The node shaft 72 passes through the display surface hole until the light node's front surface 92, seen in FIG. 11, comes into contact with the non-display side 40 of display surface 12. Threaded nut 76 is positioned over both the node shaft 72 and dome 80 and is turned, which causes internal threads 78 to grip the correspondingly sized threads 84 on shaft 72, which is shown in FIG. 7. The nut and dome may be pre-affixed to the display side 18 of the display surface prior to installation of the light node with glue or other suitable adhesive. The turning motion draws the node head 88 against the non-display side 40 of the display surface 12 and the threaded nut 76 against the display side 18 of the display surface until the node is sufficiently compressed and secured against the display surface 12, as shown in FIG. 6. Node head 88 is oversized to have a diameter greater than the predetermined hole in the display surface. The turning motion also secures light dome 80 over shaft 72; nut 76 forms a lip 86 that fits over the light dome and compresses the dome against shaft 72. The nut 76 also may be glued to the light node 16, thereby securing the node to the display surface. LED's 30 and the light dome 80 protrude through and are visible from the display side 18 of the display surface, and the securing nut 76 is also positioned on the display side 18 of the display surface. With reference to FIG. 8, the node head is secured on the non-display side 40 of the display surface 12, with the wire cable 24 running therethrough.

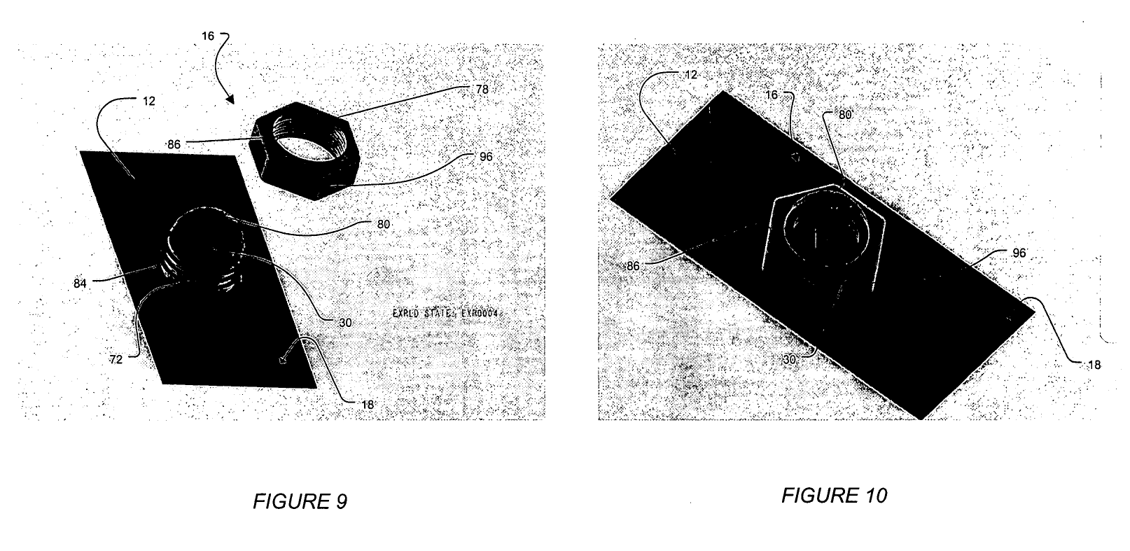

A further embodiment, shown in FIGS. 9 and 10, provides for securing LED light node 16 to a rigid or non-rigid display surface material 12 by a substantially hexagonal deep nut 96. FIG. 9 is an exploded view of these components and illustrates their configuration as seen prior to installation. During installation of the light node, the node shaft 72 is received through the display surface 12 to its display side 18 and the light dome 80 is fitted over the LED's 30. Threaded hexagonal nut 96 is positioned over both the node shaft 72 and dome 80 and is turned, which causes internal threads 78 to grip the correspondingly sized threads 84 on shaft 72. The turning motion draws the node head 88 against the non-display side 40 of the display surface 12 and the threaded hexagonal nut 96 against the display side 18 of the display surface until the node is sufficiently compressed and secured against the display surface, as shown in FIG. 10. The nut 96 also may be glued to the light node 16, thereby securing the node to the display surface. LED's 30 and the light dome 80 protrude through and are visible from the display side 18 of the display surface, and the securing hexagonal nut 96 is also positioned on the display side 18 of the display surface.

Once LED light nodes 16 are secured through display surface 12 in their operational positions, the nodes are configured to be activated or driven. The LED light strings 22 are arranged on the display surface to have one end lead to an edge, either horizontal or vertical, of the display surface. The light strings are then connected by male and female connectors (not shown) or other suitable means, to a network power supply and hub, which are in turn connected to a programmable processor 14. The processor may be housed in a computer or other device controllable to drive the color and intensity of the LED light nodes. In one embodiment, each LED light node 16 contains preinstalled LED's and a microcontroller (not shown). The microcontroller is in communication and operates in conjunction with the programmable processor 14 to control power, intensity, color, duration, and other variables of the LED's in the light node 16.

With the foregoing components configured as described, the display system 10 has the capability to produce a variety of computer-driven light colors, intensities, patterns, animation, matrixes, fonts, and other images. The LED light nodes and LED light strings may be positioned in any suitable patterns, which allows for varied illumination designs. The display system may also function as a feedback system, where the display is driven responsive to music, video, or other modulated waveform. Accordingly, the display system is versatile and may be applied to events at arenas, theatres and other public gatherings or venues to display or communicate stationary or animated images, patterns, and text on a large scale that is visible to sizeable audiences or from a distance.

Although various representative embodiments of this invention have been described above with a certain degree of particularity, those skilled in the art could make numerous alterations to the disclosed embodiments without departing from the spirit or scope of the inventive subject matter set forth in the specification and claims. The LED light nodes described herein may be replaced or supplemented with fiber optic lighting or other suitable variations. For example, with reference to FIGS. 1C and 1D, a schematic view of a non-display side 40 (FIG. 1C) and a display side (FIG. 1D) of a display system 10 with a display surface 12 is shown in accordance with one embodiment of the present invention, wherein the light nodes 16 are supplemented with optical fibers 44 that are extended from a fiber illuminator 42 to points 46 on the non-display side 40 of display surface 12 (FIG. 1C) and threaded therethrough to the display side 18 and secured at points 46 (FIG. 1D). For example, the optical fibers 44 may be positioned on the display surface 12 at points 46 such that points 46 are randomly selected, thereby creating a star field effect mimicking a nighttime sky to supplement the lights emitted from light nodes 16. Other alterations may be made within the spirit and scope of the present invention.

What is claimed is:

1. A system for mounting lights on a display surface, comprising:
a display surface having a display side and a non-display side, the display surface defining one or more holes therethrough;
one or more fasteners corresponding to each of the one or more holes, wherein each fastener defines a central opening and is arranged on the display side of the display surface, such that the central opening of the one or more fasteners is substantially aligned with the one or more holes; and
one or more light nodes contained in a light string, each light node containing a light source situated within the light node, wherein each of the light nodes is arranged with the light source protruding from the non-display side of the display surface through the hole to the display side of the display surface and through the central opening of the fastener, such that the fastener is fixedly secured to the light node thereby compressing the fastener against the display side of the display surface and compressing the light node against the non-display side of the display surface.

2. The system as recited in claim 1, wherein the one or more light nodes define a flange, the flange having a diameter greater than that of the one or more holes, and wherein the flange is compressed against the non-display side of the display surface.

3. The system as recited in claim 1, wherein the fastener is a threaded fastener, defining internal threads surrounding the central opening.

4. The system as recited in claim 3, wherein the one or more light nodes include external threads that correspond to the internal threads of the threaded fastener, and wherein the fastener is fixedly secured to the light node whereby the internal threads receive and are rotationally fastened to the external threads.

5. The system as recited in claim 1, wherein the fastener is substantially hexagonal.

6. The system as recited in claim 1, wherein the fastener is a grommet, the central opening of the grommet being sized to friction fit the portion of the light node protruding through the hole to the display side of the display surface.

7. The system as recited in claim 1, wherein the fastener is fixedly secured to the light node with an adhesive.

8. The system as recited in claim 1, further comprising a light dome corresponding to each of the one or more light nodes, the light dome substantially encapsulating the light source.

9. The system as recited in claim 8, wherein the light dome is arranged on the display side of the display surface and is compressed between the fastener and the light node.

10. The system as recited in claim 1, wherein the display surface is non-rigid.

11. The system as recited in claim 10, wherein the display surface comprises a curtain.

12. The system as recited in claim 10, wherein the display surface comprises a fabric.

13. The system as recited in claim 1, wherein the display surface is rigid.

14. The system as recited in claim 13, wherein the display surface comprises a rigid plastic.

15. The system as recited in claim 13, wherein the display surface comprises a metal.

16. The system as recited in claim 1, wherein each light node further contains a microcontroller, the microcontroller being in electrical communication with the light source.

17. A method of mounting lights on a display surface, comprising the following steps:
providing a non-rigid display surface having a display side and a non-display side;
forming one or more holes through the non-rigid display surface;
arranging one or more fasteners corresponding to each of the one or more holes, wherein each fastener defines a central opening and is arranged on the display side of the display surface, such that the central opening of the one or more fasteners is substantially aligned with the one or more holes;
providing one or more light nodes contained in a light string, each light node containing a light source situated within the light node;
projecting the light source of each of the light nodes from the non-display side of the display surface through a corresponding hole to the display side of the display surface and through the central opening of a corresponding fastener; and
securing the fastener to the light node such that the fastener is compressed against the display side of the display surface and the light node is compressed against the non-display side of the display surface.

18. The method of mounting lights on a display surface as recited in claim 17, wherein:
the one or more light nodes define a flange, the flange having a diameter greater than that of the one or more holes; and
the step of securing the fastener to the light node includes compressing the flange against the non-display side of the display surface.

19. The method of mounting lights on a display surface as recited in claim 17, wherein:
the fastener is a threaded fastener, defining internal threads surrounding the central opening;
the one or more light nodes include external threads that correspond to the internal threads of the threaded fastener; and
the step of securing the fastener to the light node includes rotating the fastener about the light node such that the internal threads receive the external threads and become rotationally fastened.

20. The method of mounting lights on a display surface as recited in claim 17, wherein:
the fastener is a grommet, the central opening of the grommet being sized to snugly receive the portion of the light node protruding through the hole to the display side of the display surface; and
the step of securing the fastener to the light node includes friction fitting the grommet to the light node.

21. The method of mounting lights on a display surface as recited in claim 17, wherein the step of securing the fastener to the light node includes applying adhesive between the fastener and the light node.
